(19) United States
(12) Patent Application Publication
(10) Pub. No.: US 2007/0239579 A1
(43) Pub. Date: Oct. 11, 2007

(54) Method and system for pension liability defeasance

(76) Inventors: Michael J. Gulotta, Lebanon, NJ (US); Bradford E. Klinck, Skillman, NJ (US); Scott Macey, Hillsborough, NJ (US)

Correspondence Address: Peter J. Phillips;Cooper & Dunham LLP, 1185 Avenue of the Americas, New York, NY, 10036, US

(21) Appl. No.: 11/784,556

(22) Filed: Apr. 6, 2007

Related U.S. Application Data
(60) Provisional application No. 60/790,242, filed on Apr. 6, 2006.

(51) Int. Cl. G06Q 40/00

(52) U.S. Cl. 705/35

(57) ABSTRACT

A method and system of defeasing the pension liabilities of a business entity as a sponsor of an employee pension plan, comprises determining the value of the existing assets and liabilities associated with a pension plan of a transferor business entity; transferring the pension plan, with its associated existing assets and liabilities, from the transferor business entity to a transferee business entity; transferring pension staff employees from the employ of the transferor business entity to the employ of the transferee business entity; determining whether any shortfalls exist in existing plan assets transferred relative to existing liabilities transferred, and, to the extent that a shortfall is determined to exist, creating additional liabilities to the transferor business entity and corresponding additional assets for the transferee business entity to cover at least part of said shortfall; and securitizing and collateralizing the existing and additional assets and liabilities held by the business entities.

### BACKGROUND OF THE INVENTION

The present invention relates to a method and system for defeasing a sponsor of a pension plan of its pension liabilities so as to limit the exposure of the sponsor to volatilities of the liabilities.

Many privately sponsored pension plans are currently underfunded and impose significant cash funding burdens on and result in adverse accounting treatment for plan sponsors. Even pension plans that are currently over funded face significant and potentially adverse future contribution and accounting burdens. These burdens and adverse effects are likely to increase in the near future given funding reform bills currently being considered by legislative bodies, such as the United States Congress, and revised rules under development by the Financial Accounting Standards Board (“FASB”) in the United States.

The U.S. Securities and Exchange Commission (“SEC”) is considering both mark-to-market accounting for pension assets and liabilities and the direct recognition of net pension liabilities on balance sheets of publicly traded companies. The U.S. Congress is considering legislation that will require both increased contribution requirements and result in increased volatility by restricting current asset and liability smoothing measures.

Many companies that currently sponsor pension plans are currently evaluating their long-term commitments to such plans. Because of increasing contribution requirements, changing rules and regulations, the growing volatility associated with defined benefit pension plans, and increasing global competition, companies are increasingly freezing membership in and/or accruals under their plans and are looking for alternatives to mitigate their risks. Many plan sponsors would likely welcome a means to defease their current (and possibly any future) pension obligations if a financially, legally, and operationally sound and appropriate means were available to do so.

The Employee Retirement Income Security Act of 1974 (“ERISA”) is a U.S. federal law that sets minimum standards for most voluntarily established pension and health plans in private industry. Effectively, under existing ERISA and U.S. Tax Code, 26 U.S.C. (“Code”) rules, there are two means to effectively and legally defease pension obligations.

One means is through the purchase of lifetime annuities from a highly rated domestic (U.S. based) insurance company. This is generally an expensive venture since insurers generally use very conservative interest and other assumptions in valuing a plan's liabilities for these purposes. As a variation of the annuity purchase and distribution approach, a plan may satisfy its obligations through the distribution of lump sums, but only if elected by a participant.

The other means for a sponsor to defease liabilities is to transfer them (along with associated assets) to another company in a business transaction. The amount of assets to be transferred when less than the entire plan is transferred is determined in accordance with specific rules and requirements under ERISA, the Code and governing regulations. Generally, the transfer of all or part of the assets and liabilities of a pension plan must also be part of the sale or spin-off of part of the sponsoring company or it's participating subsidiaries or be otherwise related to a business transaction. In other words, it is generally not permissible to transfer only a pension plan from one company to another unassociated with a transfer of some business operations and its employees.

Without expensive annuity purchases that defease the liability, or equally costly bond immunization strategies that seek to mitigate risk and volatility without defeasing the liability, both of which have significant issues that have rendered these partial solutions unacceptable to most companies, there is currently no viable solution for most pension plan sponsors to eliminate these liabilities or the volatility associated with them in a cost effective manner.

### SUMMARY OF THE INVENTION

Although the invention will be described in the context of a sponsor located in or otherwise subject to U.S. laws, the present invention would be applicable to other jurisdictions having similar statutes or regulations. It may be necessary or desirable to modify one or more attributes of the inventive method and system to comply with the governmental or other requirements of such jurisdiction.

According to the invention, assuming the satisfaction of a number of specific ERISA and Code rules, a transfer of pension plan assets and liabilities can be made to a transferee entity together with the transfer of certain business operations that need not be directly proportional to the employees and operations to which the plan is directed. For example, it would be possible, under certain circumstances, to transfer a small number of active employees to another company, and to transfer the pension assets and liabilities for both them and all existing retired and other former employees to the other company. It should be noted that the pension obligation to any particular plan participant as of the time of the transfer should not be split between the two resulting plans if the current sponsor retains a portion of the plan, although the obligation for subsequent pension accruals could be retained by the seller.

According to the present invention, a method is provided wherein an employer sponsor that wants to defease itself of some or all of its pension obligations would sell a small portion of its business, such as its pension/benefit administrative and related organization and the employees thereof, to a financial buyer (i.e., a large financial organization), that would assume the legal sponsorship of the plan or the portion thereof transferred and all the compliance, funding, administrative and other obligations associated with the plan. If the plan were over-funded at the time of the transfer, the purchase price of the business transfer would reflect that. If the plan were under-funded at the time of the transfer, the transferring sponsor would be obligated to make up the shortfall, either by the promise of periodic, negotiated cash payments to the financial buyer, which would remain liable for the ultimate/long term funding of the plan, or by the one-time payment in cash or via a purchase price adjustment of the deal. The ultimate objective of the business related transfer of all or part of the pension plan for the transferring sponsor is to defease the involved pension obligations at a more advantageous cost than would be involved in a purchase of insured annuities. Any such “business” related pension transfer must satisfy a number of specific ERISA and Code requirements and would presumably, either individually or on a generic basis, be authorized or approved, either directly through formal rulings or informal decisions not to intervene, by the U.S. Department of Labor (“DOL”), the U.S. Internal Revenue Service (“IRS”) and U.S. Treasury, and the U.S. Pension Benefit Guaranty Corporation (“PBGC”). Each of these agencies would have a regulatory interest in and appropriate legal authority over the proposed pension transfers.

The federal agencies overseeing pension plans have an interest whenever the sponsorship of a plan or a part thereof is intended to be transferred to another entity. The PBGC's primary concern is to assure that sufficient assets are being transferred to underwrite the obligation being transferred and that the new sponsoring company is sound from a financial and business perspective. The PBGC has the legal right to intervene in court and seek to prevent a transfer if it determines that such would impede or hurt the financial security of the plan and some or all of its participants. As an alternative to trying to block transfers and transactions that it determines might be harmful to a plan, the PBGC often negotiates specific security arrangements with the parties to assure the long-term security of the plan. Such financial security provisions can include such matters as additional immediate cash or other contributions to the plan, pledges of security, pledges of additional future contributions, and letters of credit or other third party guarantees.

The IRS and DOL are most concerned with satisfaction of technical tax and fiduciary rules that apply to the transfer of all or a portion of a pension plan in a business transaction. Historically, most, if not all, pension transfers have involved and been related to a sale, spin-off, or other transfer of business operations in a transaction whose primary motivating purpose was the transfer of the business operations rather than the transfer of the pension plan. Under the method of the present invention, the transfer of the pension plan would generally be the primary, if not exclusive, purpose of the transaction. A transfer of a plan might be grounds to cause all or one of the federal pension agencies to challenge the proposed transfer on a number of grounds, including: (1) the transaction is a sham transaction for tax and ERISA-related purposes; (2) the transaction is a prohibited transaction under the ERISA fiduciary rules because the benefit of the transfer to the sponsor is not incidental but primary to the transaction; (3) the transaction violates the plan split or transfer rules under Tax Code, 26 U.S.C. Section 414 (1) and ERISA Section 208; (4) the transfer violates the minimum funding rules; (5) the transfer violates the Code and ERISA exclusive benefits rules; and (6) the transfer does not accomplish a total defeasement of all legal, financial and other obligations of the sponsor for the plan.

All of these issues may be successfully addressed in order to assure the satisfaction of the objectives of any such transfer. Certainly, most of these issues can be satisfactorily addressed in the abstract (i.e., design of a transaction that, on its surface, satisfies the applicable rules and requirements). Also, most of these issues may be able to be satisfactorily addressed in reality with the federal agencies if the transfer is to an entity that is considered more financially sound than the prior plan sponsor and the various technical/compliance requirements are specifically satisfied.

The present invention provides a business process whereby the current pension expense accounting under FASB and contribution volatility under the IRS Code and implementing regulations can be eliminated.

The present invention contemplates a transfer of pension assets and liabilities from their current pension plan sponsors to a consortium of investment banks and other investors better positioned to deal with the volatility and cash needs associated with pension plans.

Under the current US rules, a transfer of pension assets to an insurance company can take place once a plan has been terminated. The insurance company determines the value of assets, if any, the transferring employer must transfer or pay outside the existing plan assets in order for the insurance company to agree to take on the liability. Due to rules that affect insurers, the liability is valued by the insurer at close to 5% (as of Jan. 1, 2006) for purposes of determining any shortfall or excess.

Under existing US rules a transfer to another employer can also take place, assuming both plans allow for such a transfer and both plan sponsors agree. The amount of assets required for the transfer, if it is not 100% of the transferring plan, is set out in Internal Revenue Code (26 U.S.C.) Section 414 (1). In general, the transfer must be “incident,” i.e., must be part of a transaction between the plan sponsors and not be the sole rationale for the transaction. For SEC purposes, the liability is valued by the insurer at close to 5.5% (as of Jan. 1, 2006) for purposes of determining any shortfall or excess.

The method according to the present invention allows the transfer of frozen liabilities (retired and terminated vested employee liabilities in all cases plus active liabilities in the case of plans that have frozen future pension accruals) to a third party. In order to meet the governmental requirement that the transaction be incidental, the employer transferring the pension assets and liabilities would also transfer a number of employees, which employees may be from pension staff of the employer, and may include the entire pension staff, or substantially the entire pension staff, and perhaps other benefit administration staff. This transfer amount, because of the long-term investment horizon of the acquiring consortium, which will be able to value the liability at close to 6.5% (as of Jan. 1, 2006) for purposes of determining any shortfall or excess, will be much lower.

The method according to the present invention provides that any shortfalls in asset transfers to the consortium's plan would be made up via future payments from the transferring (transferor) employer to the investment consortium. The investment consortium, however, would have the exclusive obligation to make any required future contributions to the plan.

### DESCRIPTION OF AN EMBODIMENT

The invention provides a method of defeasing the pension liabilities of a business entity as a sponsor of an employee pension plan, comprising: a. determining the value of the existing assets and liabilities associated with a pension plan of a transferor business entity; b. transferring the pension plan, with its associated existing assets and liabilities, from the transferor business entity to a transferee business entity; c. transferring pension staff employees from the employ of the transferor business entity to the employ of the transferee business entity; and d. determining whether any shortfalls exist in existing plan assets transferred relative to existing liabilities transferred, and, to the extent that a shortfall is determined to exist, creating additional liabilities of the transferor business entity and corresponding additional assets for the transferee business entity to cover at least part of said shortfall.

The method may further including the step of (e) securitizing and collateralizing the existing and any additional assets and liabilities held by the business entities. The step (c) of transferring pension staff employees may comprise transferring substantially all of the pension staff employees. The step (d) may comprise creating additional liabilities and corresponding additional assets to cover substantially all of said shortfall. The valuation of liabilities may be performed based upon an interest rate different from that used for governmental regulatory bodies or agencies, such as the IRS, PBGC, or FASB. The liabilities may be valued using an interest rate methodology that assumes 70% of the assets are invested in investment grade fixed income securities, based upon the most recent Moody's or Standard and Poor's evaluation, and 30% of the assets are assumed invested in equities of US firms. The liabilities maybe valued using an interest rate methodology that assumes that equities will earn the average (on a geometric return basis) return of the US equity market over the past 30 years, using the Russell 3000 Index, and that assumes that investment grade fixed income securities will use as their return index the Lehman Brothers Investment grade index over a similar period and calculated in a similar manner. The calculation of the liability may be determined using an AonVal computer valuation system, a proprietary product available from Aon Corporation, Chicago, Ill., or one of its related companies. The valuation of the assets may be performed based upon fair market value for assets having readily available market value (such as stocks in publicly held companies), and for assets not having readily obtainable market value (such as stocks in privately held companies or real estate) the valuation may be based on at least one of (a) requiring liquidation of the assets into cash or cash equivalents, or (b) using generally acceptable methodologies including audited financial statements filed within the past twelve months adjusted for the passage of time with the actual return on the US stock market over that period. The transfer of assets and liabilities in the plan may take place according to rules promulgated under Code Section 414(1). The step of transferring pension staff employees may comprise transferring employees from at least one of the following: (a) employees who respond to questions regarding pension benefits at least fifty percent of the time in the transferor business entity, and (b) employees who work in the pension department of the transferor business entity. The step of determining whether any shortfalls exist may comprise using a computer program having stored therein information representing the value of the assets and liabilities.

The invention provides a computer based system for defeasing the pension liabilities of a business entity as a sponsor of an employee pension plan, comprising: a. programmed instructions for determining the value of the existing assets and liabilities associated with a pension plan of a transferor business entity; b. programmed instructions for transferring the pension plan, with its associated existing assets and liabilities, from the transferor business entity to a transferee business entity; c. programmed instructions for transferring pension staff employees from the employ of the transferor business entity to the employ of the transferee business entity; and d. programmed instructions for determining whether any shortfalls exist in existing plan assets transferred relative to existing liabilities transferred, and, to the extent that a shortfall is determined to exist, for creating additional liabilities of the transferor business entity and corresponding additional assets for the transferee business entity to cover at least part of said shortfall.

The system may further include programmed instructions for securitizing and collateralizing the existing and any additional assets and liabilities held by the business entities. The pension staff employees transferred may comprise substantially all of the pension staff employees. The programmed instructions may create additional liabilities and corresponding additional assets to cover substantially all of said shortfall. The programmed instructions may determine the valuation of liabilities based upon an interest rate different from that used for governmental regulatory bodies or agencies. The programmed instructions may determine valuation of liabilities using an interest rate methodology that assumes 70% of the assets are invested in investment grade fixed income securities, based upon the most recent Moody's or Standard and Poor's evaluation, and 30% of the assets are assumed invested in equities of US firms. The programmed instructions may determine the valuation of liabilities using an interest rate methodology that assumes that equities will earn the average (on a geometric return basis) return of the US equity market over the past 30 years, using the Russell 3000 Index as the measure, and that assumes that investment grade fixed income securities use as their return index the Lehman Brothers Investment grade index over a similar period and calculated in a similar manner. The programmed instructions for determining the valuation of liabilities may comprise instructions from an AonVal computer valuation system. The programmed instructions may determine the valuation of assets based upon fair market value for assets having readily available market value, and for assets not having readily available market value the valuation may be based on at least one of (a) requiring liquidation of the assets into cash or cash equivalents, or (b) using generally acceptable methodologies including audited financial statements filed within the past twelve months adjusted for the passage of time with the actual return on the US stock market over that period. The programmed instructions may transfer assets and liabilities in the plan in compliance with Code Section 414(1). The pension staff employees transferred may comprise employees from at least one of the following: (a) employees who respond to questions regarding pension benefits at least fifty percent of the time in the transferor business entity, and (b) employees who work in the pension department of the transferor business entity. The programmed instructions may determine whether any shortfalls exist using information representing the value of the assets and liabilities.

A description of an embodiment will be given as one example for practicing the present invention. The invention is not limited to this example, as variations will occur to those skilled in the art.

A company with a frozen pension plan has $100 million in pension assets valued at market value. Its liabilities, based upon PBGC interest rates and other PBGC mandated assumptions, are $140 million, so the plan is underfunded by $40 million on this basis. Based upon an appropriate interest rate for a long-term portfolio return of 6.5% (this is based on an assumed mix of 70% of the portfolio in investment grade bonds and 30% in equities), the liabilities are valued using AONVal and Aon actuaries best assumptions for future expected mortality and other risks. The result of this valuation is that the pension plan's liability value is calculated to be $120 million (so a $20 million shortfall exists).

The company sells its internal pension administration group and its asset management staff to a consortium, along with the underfunded pension plan. Due to the underfunded nature of the pension plan, the purchase price associated with the sale of the internal pension and asset management staff functions is adjusted by $20 million.

The consortium takes over responsibility for the frozen pension plan, including but not limited to the obligation to make contributions, pay benefits, and keep the plan consistent with and in accordance with legislation and regulations. To the extent the consortium already operates at least one other pension plan, it may decide to merge the recently purchased plan with its existing plan, but it does not need to do so.

One or more of the steps described above or elsewhere herein may be performed using one or more computer systems having programmed instructions for executing one or more of the steps. The programmed instructions may reside in one program, or in two or more programs.

One example of a method and system according to the invention has been described, but the invention is not limited to this example, as modifications and variations will occur to those skilled in the art. The invention shall be defined by way of the following claims.

We claim:

1. A method of defeasing the pension liabilities of a business entity as a sponsor of an employee pension plan, comprising:
a. determining the value of the existing assets and liabilities associated with a pension plan of a transferor business entity;
b. transferring the pension plan, with its associated existing assets and liabilities, from the transferor business entity to a transferee business entity;
c. transferring pension staff employees from the employ of the transferor business entity to the employ of the transferee business entity; and
d. determining whether any shortfalls exist in existing plan assets transferred relative to existing liabilities transferred, and, to the extent that a shortfall is determined to exist, creating additional liabilities of the transferor business entity and corresponding additional assets for the transferee business entity to cover at least part of said shortfall.

2. The method according to claim 1, further including the step of (e) securitizing and collateralizing the existing and any additional assets and liabilities held by the business entities.

3. The method according to claim 1, wherein the step (c) of transferring pension staff employees comprises transferring substantially all of the pension staff employees.

4. The method according to claim 1, wherein the step (d) comprises creating additional liabilities and corresponding additional assets to cover substantially all of said shortfall.

5. The method according to claim 1, wherein the valuation of liabilities is performed based upon an interest rate different from that used for governmental regulatory bodies or agencies.

6. The method according to claim 1, wherein the liabilities are valued using an interest rate methodology that assumes 70% of the assets are invested in investment grade fixed income securities, based upon the most recent Moody's or Standard and Poor's evaluation, and 30% of the assets are assumed invested in equities of US firms.

7. The method according to claim 1, wherein the liabilities are valued using an interest rate methodology that assumes that equities will earn the average (on a geometric return basis) return of the US equity market over the past 30 years, using the Russell 3000 Index, and that assumes that investment grade fixed income securities will use as their return index the Lehman Brothers Investment grade index over a similar period and calculated in a similar manner.

8. The method according to claim 1, wherein a calculation of the liability is determined using an AonVal computer valuation system.

9. The method according to claim 1, wherein the valuation of the assets is performed based upon fair market value for assets having easily obtainable market value, and for assets not having easily obtainable market value the valuation is based on at least one of (a) requiring liquidation of the assets into cash or cash equivalents, or (b) using generally acceptable methodologies including audited financial statements filed within the past twelve months adjusted for the passage of time with the actual return on the US stock market over that period.

10. The method according to claim 1, wherein the transfer of assets and liabilities in the plan takes place according to rules promulgated under Code Section 414(1).

11. The method according to claim 1, wherein the step of transferring pension staff employees comprises transferring employees from at least one of the following: (a) employees who respond to questions regarding pension benefits at least fifty percent of the time in the transferor business entity, and (b) employees who work in the pension department of the transferor business entity.

12. The method according to claim 1, wherein the step of determining whether any shortfalls exist comprises using a computer program having stored therein information representing the value of the assets and liabilities.

13. A computer based system for defeasing the pension liabilities of a business entity as a sponsor of an employee pension plan, comprising:
a. programmed instructions for determining the value of the existing assets and liabilities associated with a pension plan of a transferor business entity;
b. programmed instructions for transferring the pension plan, with its associated existing assets and liabilities, from the transferor business entity to a transferee business entity;
c. programmed instructions for transferring pension staff employees from the employ of the transferor business entity to the employ of the transferee business entity; and
d. programmed instructions for determining whether any shortfalls exist in existing plan assets transferred relative to existing liabilities transferred, and, to the extent that a shortfall is determined to exist, for creating additional liabilities of the transferor business entity and corresponding additional assets for the transferee business entity to cover at least part of said shortfall.

14. The system according to claim 13, further including programmed instructions for securitizing and collateralizing the existing and any additional assets and liabilities held by the business entities.

15. The system according to claim 13, wherein the pension staff employees transferred comprises substantially all of the pension staff employees.

16. The system according to claim 13, wherein the programmed instructions create additional liabilities and corresponding additional assets to cover substantially all of said shortfall.

17. The system according to claim 13, wherein the programmed instructions determine the valuation of liabilities based upon an interest rate different from that used for governmental regulatory bodies or agencies.

18. The system according to claim 13, wherein the programmed instructions determine valuation of liabilities using an interest rate methodology that assumes 70% of the assets are invested in investment grade fixed income securities, based upon the most recent Moody's or Standard and Poor's evaluation, and 30% of the assets are assumed invested in equities of US firms.

19. The system according to claim 13, wherein the programmed instructions determine valuation of liabilities using an interest rate methodology that assumes that equities will earn the average (on a geometric return basis) return of the US equity market over the past 30 years, using the Russell 3000 Index as the measure, and that assumes that investment grade fixed income securities use as their return index the Lehman Brothers Investment grade index over a similar period and calculated in a similar manner.

20. The system according to claim 13, wherein the programmed instructions for determining the valuation of liabilities comprise instructions from an AonVal computer valuation system.

21. The system according to claim 13, wherein the programmed instructions determine the valuation of assets based upon fair market value for assets having easily obtainable market value, and for assets not having easily obtainable market value the valuation is based on at least one of (a) requiring liquidation of the assets into cash or cash equivalents, or (b) using generally acceptable methodologies including audited financial statements filed within the past twelve months adjusted for the passage of time with the actual return on the US stock market over that period.

22. The system according to claim 13, wherein the programmed instructions transfer assets and liabilities in the plan in compliance with Code Section 414(1).

23. The system according to claim 13, wherein the pension staff employees transferred comprises employees from at least one of the following: (a) employees who respond to questions regarding pension benefits at least fifty percent of the time in the transferor business entity, and (b) employees who work in the pension department of the transferor business entity.

24. The system according to claim 13, wherein the programmed instructions determine whether any shortfalls exist using information representing the value of the assets and liabilities.
